(19) United States
(12) Patent Application Publication
(10) Pub. No.: US 2019/0286454 A1
(43) Pub. Date: Sep. 19, 2019

(54) CONTROL DEVICE, PROGRAM UPDATE METHOD, AND COMPUTER PROGRAM

(71) Applicant: SUMITOMO ELECTRIC INDUSTRIES, LTD., Osaka-shi, Osaka (JP)

(72) Inventor: Yuki Sano, Osaka-shi, Osaka (JP)

(73) Assignee: SUMITOMO ELECTRIC INDUSTRIES, LTD., Osaka-shi, Osaka (JP)

(21) Appl. No.: 16/345,141

(22) PCT Filed: Aug. 4, 2017
(86) PCT No.: PCT/JP2017/028470

§ 371 Date: Apr. 25, 2019

(30) Foreign Application Priority Data
Oct. 27, 2016 (JP) 2016-210174

(51) Int. Cl. G06F 9/445; G06F 8/65; B60R 16/023; G08G 1/01

(52) U.S. Cl. CPC G06F 9/44505; G08G 1/0125; B60R 16/0231; G06F 8/66

(57) ABSTRACT

A control apparatus configured to control updating of a control program of an on-vehicle control device configured to control a target device installed in a vehicle, the control apparatus including: a prediction unit configured to predict, on the basis of signal information, a stopping time period of the vehicle caused by waiting for a traffic signal; an acquisition unit configured to acquire an updating time period, the updating time period being a time period required in updating of the control program; and a determination unit configured to determine whether or not updating of the control program during the waiting for the traffic signal is possible, on the basis of a result of comparison between the stopping time period and the updating time period.

### TECHNICAL FIELD

The present invention relates to a control apparatus, a program updating method, and a computer program.

This application claims priority on Japanese Patent Application No. 2016-210174 filed on Oct. 27, 2016, the entire content of which is incorporated herein by reference.

### BACKGROUND ART

In the technical field of automobiles in recent years, vehicles are more and more sophisticated in functionality, and various on-vehicle devices are installed in vehicles. Thus, a vehicle has installed therein a large number of so-called ECUs (Electronic Control Unit), which are control devices for controlling on-vehicle devices.

Examples of the types of the ECU include: a traveling-system ECU which controls the engine, the brake, EPS (Electric Power Steering), or the like in response to an operation performed on the accelerator, the brake, or the steering wheel; a body-system ECU which performs control of turning on/off in-vehicle illumination and the headlight, causing an alarm to sound, or the like; and a meter-system ECU which controls operation of a meter provided near the driver seat.

In general, an ECU is implemented as an arithmetic processing unit such as a microcomputer, and the ECU reads out and executes a control program stored in a ROM (Read Only Memory), thereby realizing control of an on-vehicle device.

The control program of the ECU could be different depending on the destination, the grade, and the like of the vehicle, and the old version of the control program needs to be overwritten with the new version of the control program in accordance with updating of the control program.

For example, PATENT LITERATURE 1 discloses a technology in which a gateway such as an on-vehicle communication unit receives updating programs from a management server, and ECUs respectively overwrite the old versions of the control programs with the new versions of the control programs by using the received updating programs, whereby program update for each ECU in the vehicle is remotely executed through wireless communication.

### CITATION LIST

### Patent Literature

PATENT LITERATURE 1: Japanese Laid-Open Patent Publication No. 2007-65856

### SUMMARY OF INVENTION

According to an embodiment, a control apparatus is configured to control updating of a control program of an on-vehicle control device configured to control a target device installed in a vehicle. The control apparatus includes: a prediction unit configured to predict, on the basis of signal information, a stopping time period of the vehicle caused by waiting for a traffic signal; an acquisition unit configured to acquire an updating time period, the updating time period being a time period required in updating of the control program; and a determination unit configured to determine whether or not updating of the control program during the waiting for the traffic signal is possible, on the basis of a result of comparison between the stopping time period and the updating time period.

According to another embodiment, a program updating method is a method for updating a control program of an on-vehicle control device configured to control a target device installed in a vehicle. The method includes: predicting, on the basis of signal information, a stopping time period of the vehicle caused by waiting for a traffic signal; acquiring an updating time period, the updating time period being a time period required in updating of the control program; and determining whether or not updating of the control program during the waiting for the traffic signal is possible, on the basis of a result of comparison between the stopping time period and the updating time period.

According to another embodiment, a computer program is configured to cause a computer to function as a control apparatus configured to control updating of a control program of an on-vehicle control device configured to control a target device installed in a vehicle. The computer program causes the computer to function as: a prediction unit configured to predict, on the basis of signal information, a stopping time period of the vehicle caused by waiting for a traffic signal; an acquisition unit configured to acquire an updating time period, the updating time period being a time period required in updating of the control program; and a determination unit configured to determine whether or not updating of the control program during the waiting for the traffic signal is possible, on the basis of a result of comparison between the stopping time period and the updating time period.

### BRIEF DESCRIPTION OF DRAWINGS

FIG. 1 is a diagram showing an overall configuration of a program updating system according to an embodiment.

FIG. 2 is a block diagram showing the internal configuration of a gateway.

FIG. 3 is a block diagram showing the internal configuration of an ECU.

FIG. 4 is a block diagram showing the internal configuration of a management server.

FIG. 5 is a sequence diagram showing an example of updating of a control program of an ECU.

FIG. 6 is a flow chart showing the specific content of the process, in step S5A shown in FIG. 5, of determining whether or not updating of a control program is possible, according to a first embodiment.

FIG. 7 is a flow chart showing the specific content of the process, in step S5A shown in FIG. 5, of determining whether or not updating of a control program is possible, according to a second embodiment.

### DESCRIPTION OF EMBODIMENTS

### Problems to be Solved by the Disclosure

Depending on the ECU or the control program for which overwriting is to be performed, overwriting can be performed while the vehicle is traveling, but in some cases, the function to be controlled by the ECU cannot be used during the overwriting. In a case where the function is related to traveling of the vehicle, if overwriting of the control program is performed while the vehicle is traveling, there is a risk that the traveling of the vehicle is hindered.

An object according to an aspect of the present disclosure is to provide a control apparatus, a program updating method, and a computer program that can update the control program at an appropriate timing.

### Effects of the Present Disclosure

According to this disclosure, the control program can be updated at an appropriate timing.

### Description of Embodiments

The embodiments of the present disclosure include at least the following.

That is, a control apparatus included in the present embodiment is a control apparatus configured to control updating of a control program of an on-vehicle control device configured to control a target device installed in a vehicle. The control apparatus includes: a prediction unit configured to predict, on the basis of signal information, a stopping time period of the vehicle caused by waiting for a traffic signal; an acquisition unit configured to acquire an updating time period, the updating time period being a time period required in updating of the control program; and a determination unit configured to determine whether or not updating of the control program during the waiting for the traffic signal is possible, on the basis of a result of comparison between the stopping time period and the updating time period.

According to this configuration, if the relationship between the stopping time period and the updating time period in which updating of the control program is permitted, and the relationship between the stopping time period and the updating time period in which updating of the control program is not permitted are specified in advance, it is possible to prevent the control program from being updated when the stopping time period and the updating time period satisfy the specified relationship. Accordingly, it is possible to prevent travelling of the vehicle from being hindered due to restriction of use of the target device during the updating of the control program.

Preferably, when the updating time period is shorter than the stopping time period, the determination unit permits updating of the control program during the waiting for the traffic signal.

Accordingly, updating of the control program can be performed in the stopping time period in which the vehicle is waiting for the traffic signal.

Preferably, in a case where the control program is a control program of which updating during the waiting for the traffic signal, during traveling of the vehicle, is not permitted, the determination unit does not permit updating of the control program during traveling of the vehicle, without performing the comparison between the stopping time period and the updating time period.

Examples of the control program of which updating during the waiting for the traffic signal is not permitted include a control program which causes the driving operability by the driver to be different before and after the updating. If such a control program is updated while the vehicle is waiting for the traffic signal, the driving operability by the driver becomes different due to the presence of stopping of the vehicle which is waiting for the traffic signal, and this gives the driver a strange feeling or confusion. By not permitting updating of such a control program during traveling, it is possible to prevent the driver from having a strange feeling or the like caused by change of the driving operability during traveling before and after the waiting for the traffic signal.

Preferably, the determination unit calculates the updating time period so as to be long by use of a predetermined margin, or calculates the stopping time period so as to be short by use of the predetermined margin.

Accordingly, it is determined whether or not updating of the control program is surely completed while the vehicle is stopped.

Preferably, the updating time period is calculated by a different arithmetic expression in accordance with presence or absence of a backup memory for the control program.

Accordingly, the determination accuracy can be improved.

A program updating method included in the present embodiment is a method for updating a control program of an on-vehicle control device configured to control a target device installed in a vehicle. The method includes: predicting, on the basis of signal information, a stopping time period of the vehicle caused by waiting for a traffic signal; acquiring an updating time period, the updating time period being a time period required in updating of the control program; and determining whether or not updating of the control program during the waiting for the traffic signal is possible, on the basis of a result of comparison between the stopping time period and the updating time period.

According to this configuration, if the relationship between the stopping time period and the updating time period in which updating of the control program is permitted, and the relationship between the stopping time period and the updating time period in which updating of the control program is not permitted are specified in advance, it is possible to prevent the control program from being updated when the stopping time period and the updating time period satisfy the specified relationship. Accordingly, it is possible to prevent travelling of the vehicle from being hindered due to restriction of use of the target device during the updating of the control program.

A computer program included in the present embodiment is a computer program configured to cause a computer to function as a control apparatus configured to control updating of a control program of an on-vehicle control device configured to control a target device installed in a vehicle. The computer program causes the computer to function as: a prediction unit configured to predict, on the basis of signal information, a stopping time period of the vehicle caused by waiting for a traffic signal; an acquisition unit configured to acquire an updating time period, the updating time period being a time period required in updating of the control program; and a determination unit configured to determine whether or not updating of the control program during the waiting for the traffic signal is possible, on the basis of a result of comparison between the stopping time period and the updating time period.

According to this configuration, if the relationship between the stopping time period and the updating time period in which updating of the control program is permitted, and the relationship between the stopping time period and the updating time period in which updating of the control program is not permitted are specified in advance, it is possible to prevent the control program from being updated when the stopping time period and the updating time period satisfy the specified relationship. Accordingly, it is possible to prevent travelling of the vehicle from being hindered due to restriction of use of the target device during the updating of the control program.

### Detailed Description of Embodiment

Hereinafter, preferred embodiments will be described with reference to the drawings. In the following description, the same reference numerals refer to the same components and constituent elements. The names and functions thereof are also the same. Therefore, description thereof is not repeated.

### First Embodiment

### Overall Configuration of System

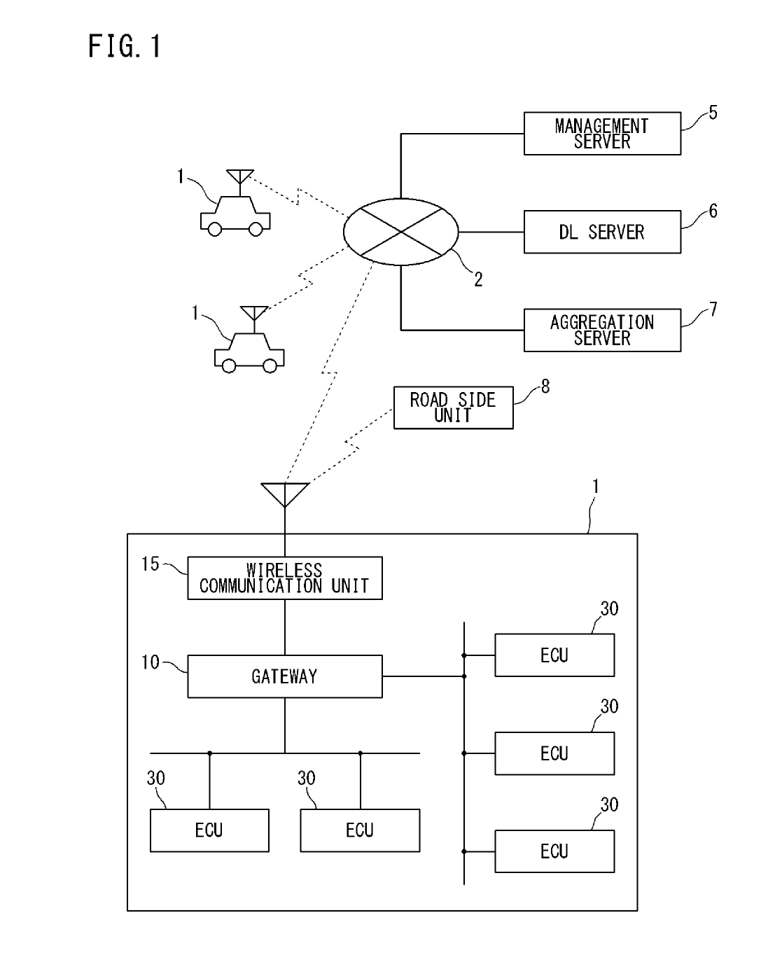

FIG. 1 is a diagram showing an overall configuration of a program updating system according to a first embodiment.

As shown in FIG. 1, the program updating system of the present embodiment includes vehicles 1, a management server 5, and a DL (download) server 6, which are able to communicate with each other via a wide-area communication network 2.

The management server 5 manages updating information of each vehicle 1. The DL server 6 stores updating programs therein. The management server 5 and the DL server 6 are operated by, for example, the automobile manufacturer of the vehicles 1, and are able to communicate with a large number of vehicles 1 owned by users registered as members in advance.

Each vehicle 1 is equipped with a gateway 10, a wireless communication unit 15, a plurality of ECUs 30, and various on-vehicle devices (not shown) controlled by the respective ECUs 30.

A plurality of communication groups, each being formed by a plurality of ECUs 30 bus-connected to a common in-vehicle communication line, are present in the vehicle 1, and the gateway 10 relays communication between the communication groups. Therefore, a plurality of in-vehicle communication lines are connected to the gateway 10.

The wireless communication unit 15 is communicably connected to the wide-area communication network 2 such as a mobile phone network, and is connected to the gateway 10 via an in-vehicle communication line. The gateway 10 transmits, to the ECUs 30, information received by the wireless communication unit 15 from external devices such as the management server 5 and the DL server 6, through the wide-area communication network 2.

The gateway 10 transmits information acquired from the ECUs 30 to the wireless communication unit 15, and the wireless communication unit 15 transmits the information to the external devices such as the management server 5.

As for the wireless communication unit 15 installed in the vehicle 1, a device possessed by the user, such as a mobile phone, a smart phone, a tablet-type terminal, or a notebook PC (Personal Computer) is conceivable, apart from a dedicated on-vehicle communication terminal.

FIG. 1 shows an exemplary case where the gateway 10 communicates with the external devices via the wireless communication unit 15. However, if the gateway 10 has a wireless communication function, the gateway 10 itself may wirelessly communicate with the external devices such as the management server 5.

In the program updating system shown in FIG. 1, the management server 5 and the DL server 6 are configured as separated servers. However, these servers 5 and 6 may be configured as a single server unit.

### Internal Configuration of Gateway

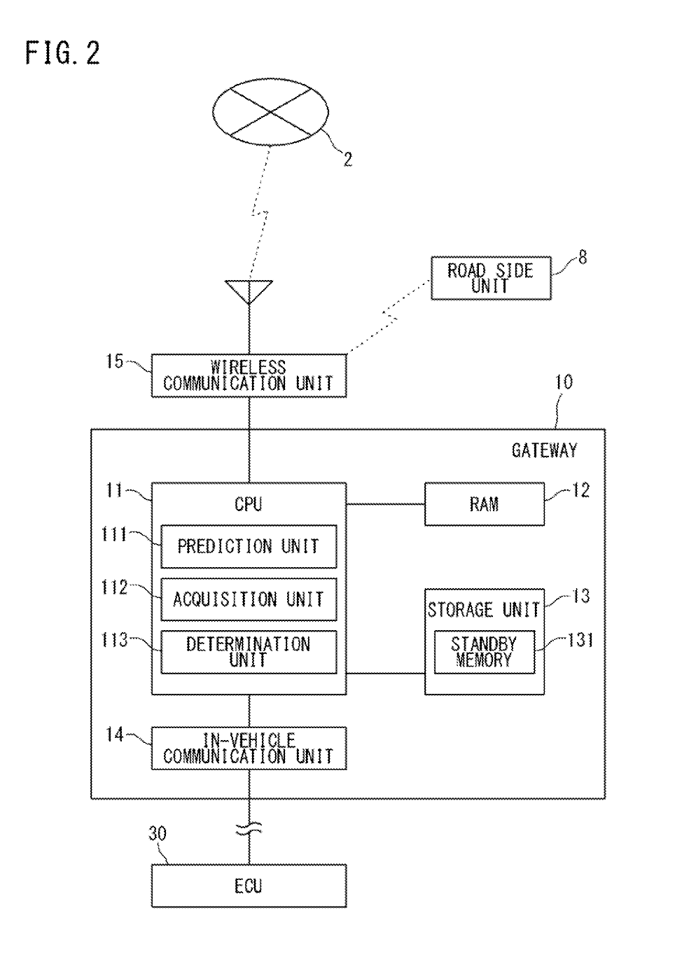

FIG. 2 is a block diagram showing the internal configuration of the gateway 10.

As shown in FIG. 2, the gateway 10 includes a CPU 11, a RAM (Random Access Memory) 12, a storage unit 13, an in-vehicle communication unit 14, and the like. Although the gateway 10 is connected to the wireless communication unit 15 via the in-vehicle communication line, the gateway 10 and the wireless communication unit 15 may be configured as a single unit.

The CPU 11 causes the gateway 10 to function as a relay device for relaying various kinds of information, by reading out one or a plurality of programs stored in the storage unit 13 to the RAM 12 and executing the read programs.

The CPU 11 can execute a plurality of programs in parallel by switching between the plurality of programs in a time sharing manner, for example. The CPU 11 may be a CPU representing a plurality of CPU groups. In this case, a function to be implemented by the CPU 11 is a function to be implemented by the plurality of CPU groups in cooperation with each other. The RAM 12 consists of a memory element such as an SRAM (Static RAM) or a DRAM (Dynamic RAM), and temporarily stores therein programs to be executed by the CPU 11, data required in executing the programs, and the like.

A computer program implemented by the CPU 11 can be transferred in a state of being recorded in a well-known recording medium such as a CD-ROM or a DVD-ROM, or may be transferred by data transmission (download) from a computer device such as a server computer.

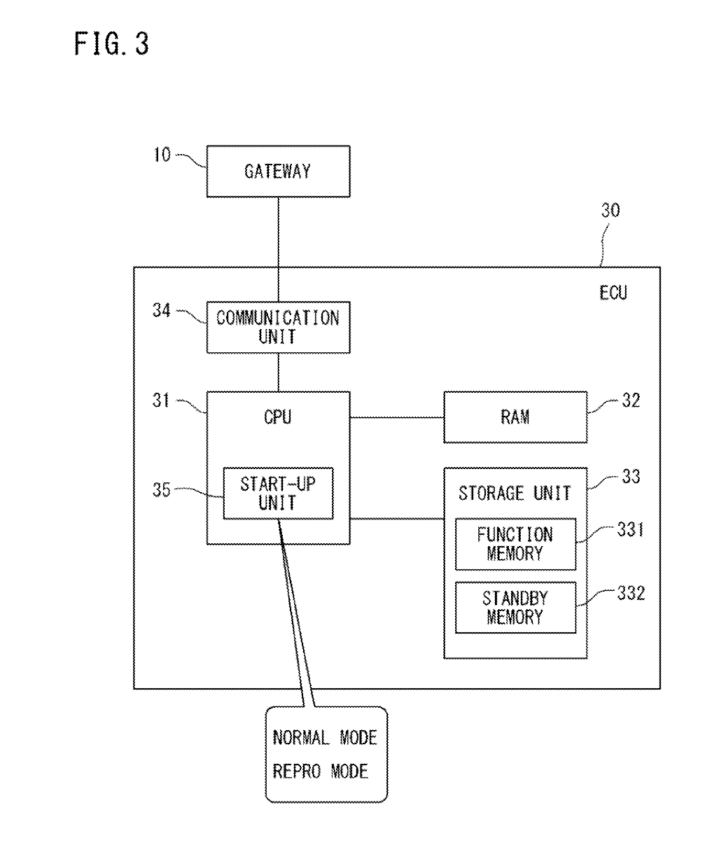

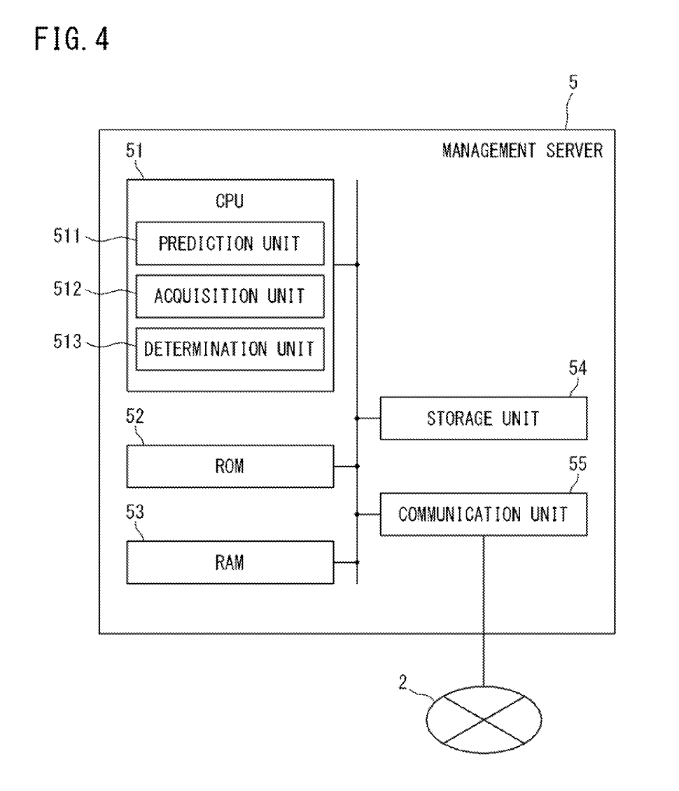

In this aspect, the same applies to a computer program to be executed by a CPU 31 of the ECU 30 (refer to FIG. 3) described later, and a computer program to be executed by a CPU 51 of the management server 5 (refer to FIG. 4) described later.

The storage unit 13 consists of, for example, a nonvolatile memory element such as a flash memory or an EEPROM. The storage unit 13 has a storage area in which programs to be executed by the CPU 11, data required in executing the programs, and the like are stored. In the storage unit 13, updating programs of the respective ECUs 30, received from the DL server 6, and the like are also stored.

The plurality of ECUs 30 are connected to the in-vehicle communication unit 14 via the in-vehicle communication lines arranged in the vehicle 1. The in-vehicle communication unit 14 communicates with the ECUs 30 in accordance with a standard such as CAN (Controller Area Network), CANFD (CAN with Flexible Data Rate), LIN (Local Interconnect Network), Ethernet (registered trademark), or MOST (Media Oriented Systems Transport: MOST is a registered trademark), for example.

The in-vehicle communication unit 14 transmits information provided from the CPU 11 to target ECUs 30, and provides information received from the ECUs 30 to the CPU 11. The in-vehicle communication unit 14 may communicate with the ECUs 30 in accordance with other communication standards that are used for an on-vehicle network, apart from the above communication standards.

The wireless communication unit 15 consists of a wireless communication apparatus including an antenna and a communication circuit that executes transmission/reception of radio signals through the antenna. The wireless communication unit 15 is able to communicate with the external devices when the wireless communication unit 15 is connected to the wide-area communication network 2 such as a mobile phone network.

The wireless communication unit 15 transmits information provided from the CPU 11 to the external devices such as the management server 5 via the wide-area communication network 2 formed by a base station (not shown), and provides information received from the external devices to the CPU 11.

Instead of the wireless communication unit 15 shown in FIG. 2, a wired communication unit that serves as a relay device inside the vehicle 1 may be adopted. The wired communication unit has a connector to which a communication cable conforming to a standard such as USB (Universal Serial Bus) or RS232C is connected. The wired communication unit performs wired communication with another communication device connected thereto via the communication cable.

If the other communication device and the external device such as the management server 5 can wirelessly communicate with each other via the wide-area communication network 2, the external device and the gateway 10 can communicate with each other through a communication path consisting of, in this order, the external device, the other communication device, the wired communication unit, and the gateway 10.

### Internal Configuration of ECU

FIG. 3 is a block diagram showing the internal configuration of an ECU 30.

As shown in FIG. 3, the ECU 30 includes a CPU 31, a RAM 32, a storage unit 33, a communication unit 34, and the like. The ECU 30 is an on-vehicle control device that individually controls a target device installed in the vehicle 1. Examples of the types of the ECU 30 include a power supply control ECU, an engine control ECU, a steering control ECU, and a door lock control ECU.

The CPU 31 controls the operation of a target device that the CPU 31 is in charge of, by reading out one or a plurality of programs previously stored in the storage unit 33 to the RAM 32 and executing the read programs. The CPU 31 may also be a CPU representing a plurality of CPU groups, and a control to be performed by the CPU 31 may be a control to be performed by the plurality of CPU groups in cooperation with each other.

The RAM 32 consists of a memory element such as an SRAM or a DRAM, and temporarily stores therein programs to be executed by the CPU 31, data required in executing the programs, and the like.

The storage unit 33 consist of, for example, a nonvolatile memory element such as a flash memory or an EEPROM, or a magnetic storage device such as a hard disk.

Information stored in the storage unit 33 includes, for example, a computer program (hereinafter referred to as “control program”) that causes the CPU 31 to execute information processing for controlling a target device to be controlled, inside the vehicle.

The gateway 10 is connected to the communication unit 34 via the in-vehicle communication line provided in the vehicle 1. The communication unit 34 communicates with the gateway 10 in accordance with a standard such as CAN, Ethernet, or MOST, for example.

The communication unit 34 transmits information provided from the CPU 31 to the gateway 10, and provides information received from the gateway 10 to the CPU 31. The communication unit 34 may communicate with the gateway 10 in accordance with other communication standards that are used for the on-vehicle network, apart from the above communication standards.

The CPU 31 of the ECU 30 includes a start-up unit 35 that switches the mode of control performed by the CPU 31, between a “normal mode” and a “reprogramming mode” (hereinafter also referred to as “repro mode”).

The normal mode is a control mode in which the CPU 31 of the ECU 30 executes original control for the target device (e.g., engine control for a fuel engine, or door lock control for a door lock motor).

The reprogramming mode is a control mode in which the CPU 31 updates the control program used for controlling the target device.

That is, the reprogramming mode is a control mode in which the CPU 31 performs erasing/overwriting of the control program from/on a ROM area of the storage unit 33. Only when the CPU 31 is in this control mode, the CPU 31 is allowed to update the control program stored in the ROM area in the storage unit 33 to a new version of the control program.

When the CPU 31, in the repro mode, writes the new version of the control program into the storage unit 33, the start-up unit 35 temporarily restarts (resets) the ECU 30, and executes a verifying process on a storage area where the new version of the control program has been written.

After completion of the verifying process, the start-up unit 35 causes the CPU 31 to operate with the updated control program.

### Internal Configuration of Management Server

FIG. 4 is a block diagram showing the internal configuration of the management server 5.

As shown in FIG. 4, the management server 5 includes a CPU 51, a ROM 52, a RAM 53, a storage unit 54, a communication unit 55, and the like.

By reading out one or a plurality of programs previously stored in the ROM 52 to the RAM 53 and executing the read programs, the CPU 51 controls the operation of each hardware component, and causes the management server 5 to function as an external device that is able to communicate with the gateway 10. The CPU 51 may also be a CPU representing a plurality of CPU groups, and a function to be implemented by the CPU 51 may be a function to be implemented by the plurality of CPU groups in cooperation with each other.

The RAM 53 consists of a memory element such as an SRAM or a DRAM, and temporarily stores therein programs to be executed by the CPU 51, data required in executing the programs, and the like.

The storage unit 54 consists of, for example, a nonvolatile memory element such as a flash memory or an EEPROM, or a magnetic storage device such as a hard disk.

The communication unit 55 consists of a communication device that executes a communication process in accordance with a predetermined communication standard. The communication unit 55 executes the communication process when being connected to the wide-area communication network 2 such as a mobile phone network. The communication unit 55 transmits information provided from the CPU 51 to external devices via the wide-area communication network 2, and provides information received via the wide-area communication network 2 to the CPU 51.

### Control Program Updating Sequence

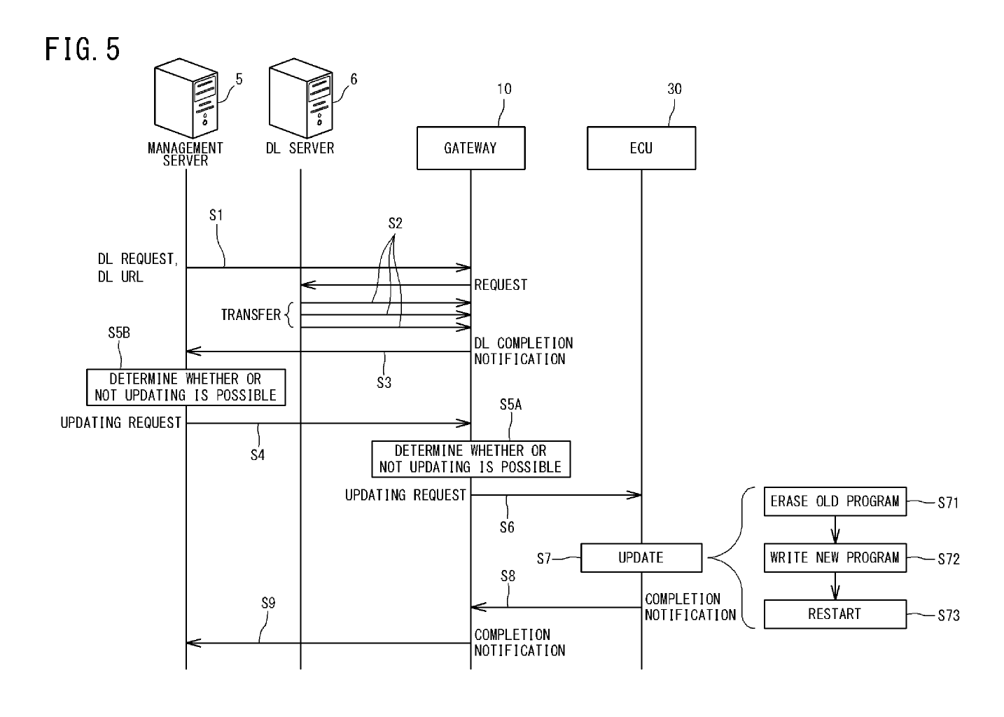

FIG. 5 is a sequence diagram showing an example of updating of a control program for an ECU, which is executed in the program updating system of the present embodiment. For example, as for a vehicle 1 that is registered in advance, the management server 5 determines the timing to update a control program of an ECU of the vehicle 1. The timing of updating may be set by, for example, the automobile manufacturer of the vehicle 1.

When the timing to update the control program of the ECU has come, the management server 5 transmits a download request and a URL where an updating program for the ECU 30 is stored, to the gateway 10 of the corresponding vehicle 1 (step S1).

Accordingly, the gateway 10 downloads the updating program for the ECU 30 from the DL server 6 (step S2). The gateway 10 temporarily stores and preserves the received updating program in the storage unit 13 thereof.

Upon completion of the storage of the updating program, the gateway 10 notifies the management server 5 that DL has been normally completed (step S3). If updating is successively performed automatically, the management server 5, which has received the DL completion notification, transmits a control program updating request to the gateway 10. After completion of the DL, the management server 5 may temporarily suspend the process, and may transmit the control program updating request to the gateway 10 upon receiving an updating request from the outside (step S4).

On the basis of a stopping time period due to a red signal, the gateway 10, which has received the updating request, determines whether or not updating of the control program in the stopping time period is possible (step S5A). When updating of the control program is to be permitted, the gateway 10 transmits a control program updating request to the ECU 30 in order to update the control program by use of the updating program stored in the storage unit 13 (step S6). In step S6, the gateway 10 may notify the user that updating of the control program is possible, thereby causing the ECU 30 to be updated in accordance with a user operation that starts updating.

Upon receiving the control program updating request, the ECU 30 switches the control mode thereof from the normal mode to the repro mode. Accordingly, the ECU becomes able to perform a control program updating process.

The ECU 30 expands the received updating program and applies the updating program to the old version of the control program, thereby overwriting the old version of the control program with the new version of the control program (step S7). Upon completion of the overwriting, the ECU 30 transmits an overwriting completion notification to the gateway 10 (step S8). Upon receiving the overwriting completion notification from the ECU 30, the gateway 10 transmits an updating completion notification to the management server 5 (step S9).

### Functional Configuration of Gateway

As functions for performing the process (step S5A) of determining whether or not updating of the control program is possible, the CPU 11 of the gateway 10 includes the functions expressed as a prediction unit 111, an acquisition unit 112, and a determination unit 113 shown in FIG. 2. These functions are functions implemented by the CPU 11 reading out one or a plurality of programs stored in the storage unit 13 and executing the programs. However, at least some of the functions may be implemented by hardware such as an electronic circuit.

The function of the CPU 11 expressed as the prediction unit 111 (hereinafter, prediction unit 111) predicts a stopping time period for which the vehicle 1 will stop at an intersection present at the downstream side due to lighting of a red light (hereinafter, red signal) of a traffic signal unit installed thereat.

The prediction unit 111 acquires, as information for prediction, information regarding the traffic signal unit from another device. The other device is, for example, a road side unit 8 which is a communication device installed at the road side and which is also called a beacon or the like, or an aggregation server 7 which aggregates traffic information such as signal information.

As shown in FIG. 1, the gateway 10 performs wireless communication with the road side unit 8. The wireless communication is optical communication, radio wave communication, or the like. The road side unit 8 that performs optical communication is also called an optical beacon. The road side unit 8 that performs radio wave communication is also called a radio beacon. Other than the above, the wireless communication is DSRC (Dedicated Short Range Communications), so-called FM communication using FM (Frequency Modulation) wave, or the like. The gateway 10 receives signal information transmitted from the road side unit 8 through the above wireless communication.

The road side unit 8 is associated with an intersection and installed at the upstream side of the intersection so that the road side unit 8 transmits signal information regarding the intersection to a vehicle which is entering the intersection. Therefore, if the vehicle 1 has received signal information from the road side unit 8, it means that the vehicle 1 is before the intersection (i.e., upstream side), i.e., the intersection is present immediately downstream of the vehicle 1.

Signal information transmitted from the road side unit 8 includes information indicating the effective time period of the information, position information of an intersection present downstream, the cycle length of a traffic signal unit installed at the intersection, and the like. Preferably, the signal information includes these pieces of information according to the position of the vehicle 1. The signal information may further include information that indicates the flow speed at the time when the vehicle departs from the position (departure traffic flow speed information). These pieces of information may be acquired from the aggregation server 7 by the gateway 10 transmitting the position information thereof to the aggregation server 7 and requesting the pieces of information.

The signal information acquired by the prediction unit 111 may be information regarding one intersection only that is located closest to and downstream of the vehicle 1, or may be information regarding one or more intersections that are located downstream, within a predetermined range, of the vehicle 1. In addition, in the case where the prediction unit 111 acquires signal information from the aggregation server 7, the prediction unit 111 may provide the aggregation server 7 with, as a predicted path, a path that is set in a navigation device (not shown), and may acquire information regarding one or more intersections on the path.

On the basis of the acquired signal information and information indicating the traveling state (position, speed, etc.) of the vehicle 1 acquired from the engine control ECU and the like, the prediction unit 111 predicts a stopping time period Ts due to a red signal at the intersection (stopping time period caused by waiting for the traffic signal).

As the method for predicting the stopping time period Ts due to a red signal, various methods have already been proposed. For example, Japanese Laid-Open Patent Publication No. 2007-56734 discloses a method for predicting a stopping time period Ts in consideration of a start-delay time period after a red signal has changed to a green signal, in addition to the time period of the red signal. The method for predicting the stopping time period Ts by the prediction unit 111 is not limited to a specific method, and may be the method disclosed by Japanese Laid-Open Patent Publication No. 2007-56734, for example.

The function of the CPU 11 expressed as the acquisition unit 112 (hereinafter, acquisition unit 112) acquires an updating time period Tr which is the time period required in updating a control program. For example, the acquisition unit 112 acquires the updating time period Tr from the management server 5. As another example, the acquisition unit 112 may calculate the updating time period Tr on the basis of the size of the updating program and the throughput of the target ECU 30.

As shown in FIG. 5, updating of the control program in step S7 includes a process of erasing the old program from the storage unit 33 of the ECU 30 (step S71), a process of writing, into the storage unit 33, a new program generated by applying the updating program to the old program (step S72), and a process of restarting the ECU 30 (step S73).

Updating of the control program performed by the ECU 30 in step S7 is different depending on the memory configuration of the target ECU 30. With reference to FIG. 3, examples of the configuration of the storage unit 33 of the ECU 30 include the following two configurations.

First configuration: a function memory 331 is included and a standby memory 332 is not included.

Second configuration: both of the standby memory 332 and the function memory 331 are included.

The standby memory 332 is an area used for backup of programs. The function memory 331 is an area for storing programs read out and executed by the CPU 31.

In the case of the first memory configuration, i.e., in the case where the standby memory 332 is not included, a standby memory 131 is prepared in the storage unit 13 of the gateway 10, as shown in FIG. 2. The gateway 10 generates a new program by applying the updating program received from the management server 5 to the old program, and stores the new program in the standby memory 131. Next, the CPU 31 of the ECU 30 having received the request from the gateway 10 executes all the steps S71 to S73 in the repro mode, and writes the new program received from the gateway 10 into the function memory 331. Thus, in the case of the first memory configuration, the updating time period Tr is expressed by the formula below by use of processing time periods T1, T2, T3 of the respective steps S71 to S73.

Tr=T1+T2+T3

In the case of the second memory configuration, i.e., in the case where the standby memory 332 is included, the CPU 31 of the ECU 30 generates a new program by applying the updating program received from the gateway 10 to the old program, and stores the new program into the standby memory 332. This process does not influence the function memory 331, and thus, is performed in the normal mode before the repro mode. Then, the CPU 31 restarts the ECU 30 in the repro mode, thereby switching the roles of the standby memory 332 and the function memory 331 with each other. That is, in the case of the second memory configuration, updating of the control program in step S7 consists of the process of restarting in step S73, only. Therefore, in the case of the second memory configuration, the updating time period Tr is expressed by the formula below.

Tr=T3

Thus, preferably, the acquisition unit 112 acquires the updating time period Tr according to whether the memory configuration of the target ECU 30 is the first memory configuration or the second memory configuration. Alternatively, the acquisition unit 112 calculates the updating time period Tr according to whether the memory configuration of the target ECU 30 is the first memory configuration or the second memory configuration, i.e., whether or not the standby memory 332 is included. As a result of the updating time period Tr being acquired or calculated in this manner, the determination accuracy can be improved.

The function of the CPU 11 expressed as the determination unit 113 (hereinafter, determination unit 113) compares the stopping time period Ts predicted by the prediction unit 111 and the updating time period Tr acquired by the acquisition unit 112 with each other, and determines, on the basis of the comparison result, whether or not updating of the control program is possible. When the stopping time period Ts is longer than the updating time period Tr, the determination unit 113 determines that updating of the control program is possible. For example, the determination unit 113 determines whether or not updating of the control program is possible, in accordance with the determination formulas below.

updating time period Tr<stopping time period Ts . . . updating is possible

updating time period Tr≥stopping time period Ts . . . updating is not possible

Preferably, the determination unit 113 adds a predetermined margin m to the updating time period Tr, compares the resultant updating time period Tr with the stopping time period Ts, and then, determines, on the basis of the comparison result, whether or not updating of the control program is possible. Accordingly, whether or not updating of the control program is surely completed while the vehicle 1 is stopped is determined. For example, if the updating time period Tr is 20 seconds, the margin m is about 10 seconds. For example, the determination unit 113 determines whether or not updating of the control program is possible, in accordance with the determination formulas below.

updating time period Tr+margin m<stopping time period Ts . . . updating is possible

updating time period Tr+margin m≥stopping time period Ts . . . updating is not possible

Adding the predetermined margin m to the updating time period Tr is equivalent to subtracting the predetermined margin m from the stopping time period Ts. That is, if expressed in another way, the above determination formulas are equivalent to the determination formulas below.

updating time period Tr<stopping time period Ts−margin m . . . updating is possible

updating time period Tr≥stopping time period Ts−margin m . . . updating is not possible

Alternatively, as with the margin m above, the determination unit 113 may compare the updating time period Tr with a time period that corresponds to a predetermined proportion α of the stopping time period Ts, and may determine, on the basis of the comparison result, whether or not updating of the control program is possible. For example, the predetermined proportion α is about 0.8. The determination unit 113 determines whether or not updating of the control program is possible, in accordance with the determination formulas below.

updating time period Tr<stopping time period Ts×α . . . updating is possible

updating time period Tr≥stopping time period Ts×α . . . updating is not possible

### Process of Determining Whether or Not Updating of Control Program is Possible

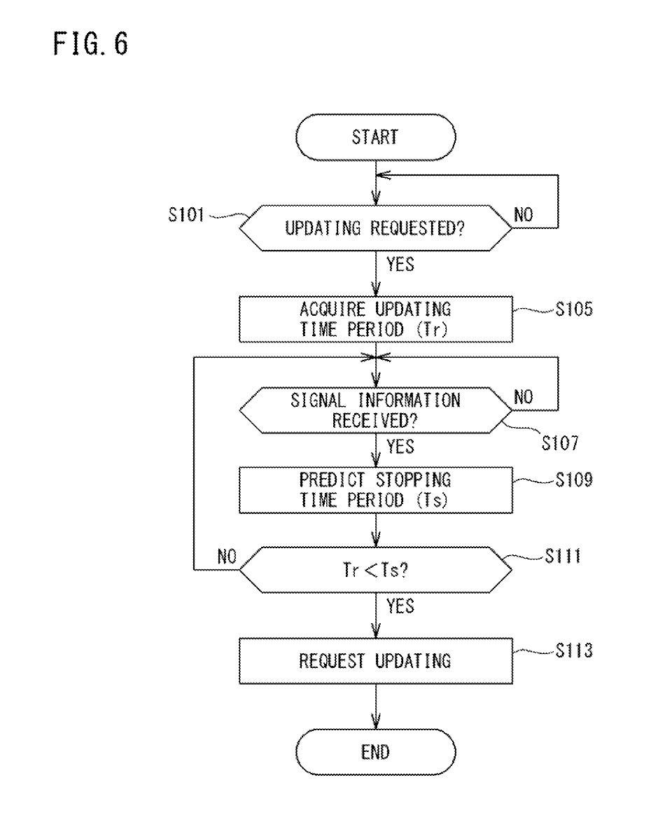

FIG. 6 is a flow chart showing the specific content of the process, in step S5A shown in FIG. 5, of determining whether or not updating of the control program is possible. The process shown in the flow chart in FIG. 6 is mainly implemented by the CPU 11 of the gateway 10, as a result of the CPU 11 reading out one or a plurality of programs stored in the storage unit 13 to the RAM 12 and executing the programs.

With reference to FIG. 6, when updating of the control program is requested from the management server 5 (YES in step S101), the CPU 11 of the gateway 10 acquires the updating time period Tr (step S105). Instead of the CPU 11 receiving the request from the management server 5, but upon detection of the fact that the updating program received from the management server 5 is stored in the memory, the CPU 11 may perform the determination thereafter.

Next, the CPU 11 waits until receiving signal information from the road side unit 8 or the like. When the CPU 11 has received the signal information (YES in step S107), the CPU 11 predicts the stopping time period Ts due to a red signal at an intersection present downstream, on the basis of the acquired signal information and information indicating the traveling state (position, speed, etc.) of the vehicle 1 (step S109).

Next, the CPU 11 compares the stopping time period Ts and the updating time period Tr with each other, and determines, on the basis of the comparison result, whether or not updating of the control program is possible. For example, when the updating time period Tr<the stopping time period Ts (YES in step S111), the CPU 11 determines that updating of the control program is possible, and requests the target ECU 30 to update the control program (step S113). Accordingly, the updating is executed.

Meanwhile, when the updating time period Tr≥the stopping time period Ts (NO in step S111), the CPU 11 determines that updating of the control program is not possible. On the basis of this determination result, the CPU 11 does not request the ECU 30 to update the control program. In this case, the CPU 11 waits until receiving the next signal information from the road side unit 8 or the like. When the CPU 11 has received the next signal information, the CPU 11 may repeat the process from step S109 again.

### Effect of the First Embodiment

According to the program updating system of the first embodiment, when the stopping time period Ts of the vehicle 1 due to a red signal is longer than the updating time period Tr (Tr<Ts), updating of the control program is executed while the vehicle 1 is stopped due to the red signal, and the updating of the control program is completed before the vehicle 1 starts moving. Thus, even in the case of updating of the control program during which the control-target function of the ECU cannot be used, traveling of the vehicle is not hindered by the updating. That is, the control program can be updated at an appropriate timing.

### Second Embodiment

Among control programs, there are control programs of which updating is not permitted at a timing, during traveling, of waiting for the traffic signal. Such a control program of which updating during traveling is not permitted will also be referred to as an unpermitted program.

Examples of the unpermitted program include a control program which causes the driving operability by the driver to be different before and after the updating. For example, such unpermitted programs are control programs of ECUs which control EPS (Electrical Power steering), EFI (Electronic Fuel Injection), and the like. Programs which are not the unpermitted programs are, for example, control programs of ECUs which control ABS (Antilock Brake System), ESP (Electronic Stability Program), automatic driving, and the like.

If the unpermitted program is updated while the vehicle is waiting for the traffic signal during traveling, the driving operability by the driver becomes different due to the presence of stopping of the vehicle which is waiting for the traffic signal. This gives the driver a strange feeling or confusion.

Therefore, preferably, the determination unit 113 determines whether or not updating is possible if the control program of which updating is requested from the management server 5 is not the unpermitted program; and does not permit start of the updating without determining whether or not the updating is possible if the control program of which updating is requested is the unpermitted program. In order to perform this determination, the determination unit 113 has stored therein in advance identification information of control programs that each correspond to the unpermitted program and/or identification information of control programs that each does not correspond to the unpermitted program. The determination as to whether or not the control program is the unpermitted program may be performed by the management server 5. In this case, the management server 5 performs the determination in advance on the control program of which updating is to be requested, and sends, a request for updating to the gateway 10, together with information indicating the determination result. That is, in this case, the determination unit 113 acquires, from the management server 5, the determination result on whether or not the control program of which updating is requested from the management server 5 is the unpermitted program.

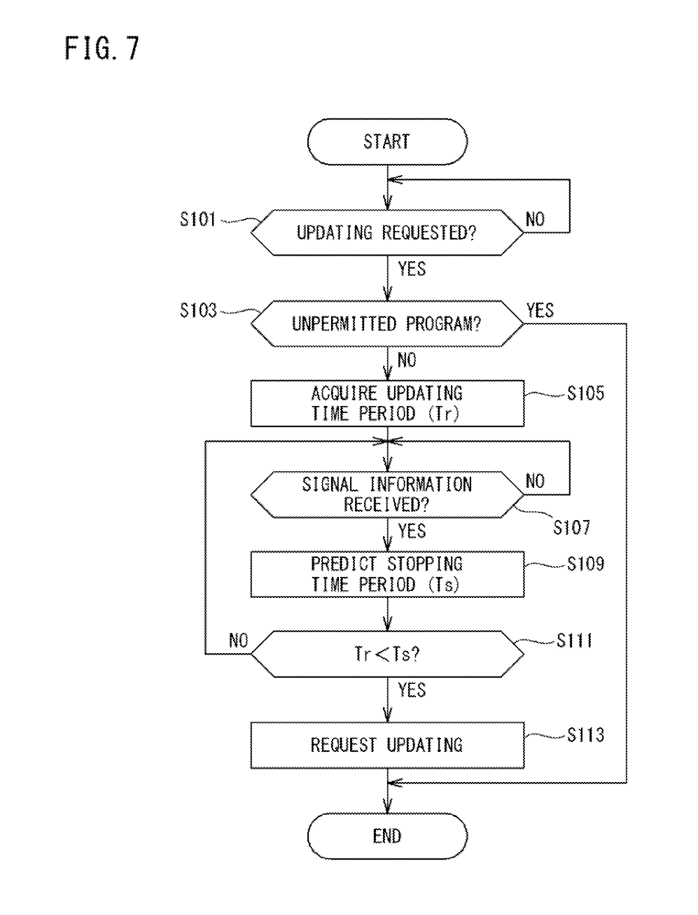

FIG. 7 is a flow chart showing the specific content of the process of determining whether or not updating of the control program is possible, according to the second embodiment. The process shown in the flow chart in FIG. 7 is also mainly implemented by the CPU 11 of the gateway 10, as a result of the CPU 11 reading out one or a plurality of programs stored in the storage unit 13 to the RAM 12 and executing the programs. In the flow chart shown in FIG. 7, processes having the same step numbers as those in the flow chart of FIG. 6 are same as the processes shown in the flow chart of FIG. 6, and the description thereof is not repeated.

With reference to FIG. 7, when updating of the control program is requested from the management server 5 (YES in step S101), the CPU 11 determines whether or not the control program is the unpermitted program. When the determination is positive (YES in step S103), the CPU 11 does not perform determination thereafter, and does not request the target ECU 30 to update the control program. Accordingly, updating of the control program is not performed during traveling of the vehicle 1.

Meanwhile, when the control program of which updating is requested is not the unpermitted program (NO in step S101), the CPU 11 performs the determination described above, and requests the target ECU 30 to update the control program, in accordance with the determination result.

### Effect of the Second Embodiment

When the control program is the unpermitted program, comparison between the stopping time period and the updating time period is not performed, and updating of the control program during traveling of the vehicle is not permitted, whereby updating of the control program is not performed during traveling of the vehicle 1. Accordingly, it is possible to prevent the driver from having a strange feeling or confusion caused by different driving operability by the driver due to the presence of stopping of the vehicle which is waiting for the traffic signal.

### Third Embodiment

In the program updating systems according to the first and second embodiments, whether or not updating of a program is possible is determined by the gateway 10. However, whether or not updating of a program is possible may be determined by a device different from the gateway 10. As another example, the management server 5 may perform the determination. The management server 5 according to a third embodiment determines whether or not updating is possible at the timing of step S5B shown in FIG. 5. That is, when the management server 5 is notified of completion of download of the updating program from the gateway 10, the management server 5 then determines whether or not updating is possible (step S5B), and requests, at the timing at which it has been determined that updating is possible, the gateway 10 to perform updating (step S4).

In this case, as shown in FIG. 4, as the functions, of the CPU 51 of the management server 5, for determining whether or not updating of the program is possible, the CPU 51 has: a prediction unit 511 corresponding to the prediction unit 111; an acquisition unit 512 corresponding to the acquisition unit 112; and a determination unit 513 corresponding to the determination unit 113. These functions are mainly implemented by the CPU 51 reading out one or a plurality of programs stored in the ROM 52 and executing the programs. However, at least some of the functions may be implemented by hardware such as an electric circuit.

It is noted that the embodiments disclosed herein are merely illustrative in all aspects and should not be recognized as being restrictive. The scope of the present invention is defined not by the above description but by the scope of the claims, and is intended to include meaning equivalent to the scope of the claims and all modifications within the scope.

### REFERENCE SIGNS LIST

1 vehicle

2 wide-area communication network

5 management server (control apparatus)

6 DL server

7 aggregation server

8 road side unit

10 gateway (control apparatus)

11 CPU (determination unit)

12 RAM

13 storage unit

14 in-vehicle communication unit

15 wireless communication unit

30 ECU (on-vehicle control device)

31 CPU

32 RAM

33 storage unit

34 communication unit

35 start-up unit

51 CPU (determination unit)

52 ROM

53 RAM

54 storage unit

55 communication unit

111, 511 prediction unit

112, 512 acquisition unit

113, 513 determination unit

131, 332 standby memory

331 function memory

1. A control apparatus configured to control updating of a control program of an on-vehicle control device configured to control a target device installed in a vehicle, the control apparatus comprising:
a prediction unit configured to predict, on the basis of traffic signal information, a stopping time period of the vehicle caused by waiting for a traffic signal;
an acquisition unit configured to acquire an updating time period, the updating time period being a time period required in updating of the control program; and
a determination unit configured to determine whether or not updating of the control program during the waiting for the traffic signal is possible, on the basis of a result of comparison between the stopping time period and the updating time period.

2. The control apparatus according to claim 1, wherein
when the updating time period is shorter than the stopping time period, the determination unit permits updating of the control program during the waiting for the traffic signal.

3. The control apparatus according to claim 1, wherein
in a case where the control program is a control program of which updating during the waiting for the traffic signal, during traveling of the vehicle, is not permitted, the determination unit does not permit updating of the control program during traveling of the vehicle, without performing the comparison between the stopping time period and the updating time period.

4. The control apparatus according to claim 1, wherein
the determination unit uses a predetermined margin in the comparison between the stopping time period and the updating time period.

5. The control apparatus according to claim 1, further comprising a storage unit including a function memory area for storing the control program executed, wherein
the updating time period is calculated in accordance with whether or not the storage unit includes a standby memory area whose role is switched to a role of the function memory area.

6. A method for updating a control program of an on-vehicle control device configured to control a target device installed in a vehicle, the method comprising:
predicting, on the basis of traffic signal information, a stopping time period of the vehicle caused by waiting for a traffic signal;
acquiring an updating time period, the updating time period being a time period required in updating of the control program; and
determining whether or not updating of the control program during the waiting for the traffic signal is possible, on the basis of a result of comparison between the stopping time period and the updating time period.

7. A non-transitory computer readable storage medium storing a computer program configured to cause a computer to function as a control apparatus configured to control updating of a control program of an on-vehicle control device configured to control a target device installed in a vehicle, the computer program causing the computer to function as:
a prediction unit configured to predict, on the basis of traffic signal information, a stopping time period of the vehicle caused by waiting for a traffic signal;
an acquisition unit configured to acquire an updating time period, the updating time period being a time period required in updating of the control program; and
a determination unit configured to determine whether or not updating of the control program during the waiting for the traffic signal is possible, on the basis of a result of comparison between the stopping time period and the updating time period.
